(19) United States
(12) Patent Application Publication
(10) Pub. No.: US 2008/0102244 A1
(43) Pub. Date: May 1, 2008

(54) Wooden newel post

(75) Inventor: Shu Wong Mak, Kowloon (HK)

Correspondence Address: SAND & SEBOLT, AEGIS TOWER, SUITE 1100, 4940 MUNSON STREET, NW, CANTON, OH, 44718-3615, US

(73) Assignee: Interwood International Limited, Kowloon (HK)

(21) Appl. No.: 11/589,346

(22) Filed: Oct. 30, 2006

(51) Int. Cl. B32B 3/02; B32B 21/04

(52) U.S. Cl. 428/57; 428/537.1; 428/157; 428/172

(57) ABSTRACT

A newel post comprising a core that has an upper portion and a lower portion with a laminate applied around the lower portion to cover minor inconsistencies in the timber. The core includes at least one single, continuous board of high quality timber which extends along the entire length of the newel post. The single board is naturally formed and is free of any joints to make up its length. The core may comprise at least one shorter second board of high quality timber that is secured to a side wall of the single board. A secondary piece of wood is secured along the side wall of the single board to equalize the lengths of the single and second boards. The secondary piece of wood is separated from the second board by a gap, thereby negating the need to form finger joints between the two. The secondary piece of wood is made from one of a high quality timber, laminated veneer lumber (LVL) and plywood that is free of pine.

### BACKGROUND OF THE INVENTION

1. Technical Field

This invention generally relates to railing systems. More particularly, the invention relates to a newel post for a staircase. Specifically, the invention relates to a newel post that includes a core that has at least one single, continuous board that extends the entire length of the core and a laminate that is affixed to a lower portion of the core.

2. Background Information

Newel posts have long been used in stair and fence systems as part of the anchoring mechanism for hand and foot rails and thereby part of the support system for the balusters. They have typically been decorative in nature so that the overall aesthetic appearance of the stair case, for example, is enhanced.

Initially, newel posts were made from solid pieces of wood as these were plentiful. If, at that time, a craftsman found that a particular piece of timber he was considering for a newel post was partially defective in that it included inconsistencies such as small holes, knots etc., he would simply reject the piece and select another. This selectiveness was not a problem in that high grade wood was plentiful and the cost of such pieces of timber was not too great.

People still desire the look and feel of high grade woods in furniture, trim and stair cases, but such high grade woods are less plentiful and are relatively very expensive. The industry has therefore addressed this issue in various ways. The first way is the practice of joining smaller, narrow pieces of high grade wood together to form boards which may then be glued together to make wider blocks of high grade wood. These boards and blocks are then used in the manufacture of furniture, newel posts, balusters etc. However, because these boards and blocks are still relatively expensive because they contain only high grade pieces of wood, the end product is still expensive. This issue has been addressed in the industry by marrying together higher and lower grades of wood and then applying a laminate or veneer of a higher grade wood over the lower grade woods to hide the same.

An example of this second solution in the newel post industry can be found in U.S. Pat. No. 6,662,519 issued to Chung. Chung discloses a newel post that has an upper portion manufactured from high grade wood and a lower portion manufactured from lower grade woods. The patent discloses that the boards used to form the block from which the newel post is lathed is formed by finger jointing smaller lengths of high grade wood to each other and then finger jointing those lengths to smaller lengths of lower grade woods. The boards so formed are then glued together to form a block where the upper portion of the block is higher grade wood and the lower portion is lower grade wood. Once the newel post is formed, a decorative lamella is applied over the lower grade woods at the lower end of the newel post. The newel post then has the appearance of being made from a high grade piece of wood along its entire length.

However, this method of producing a newel post is fairly labor intensive and time consuming in that finger joints have to be cut in each of the smaller sections of wood, which are then joined together to form boards, which then need to be glued together to form the initial block from which the post is lathed.

There is therefore a need in the art for an improved newel post that has the appearance of being a high grade and quality wood along its entire length but that does not require the same degree of labor and time to manufacture the same as have previous newel posts.

### SUMMARY OF THE INVENTION

The device of the present invention comprises a newel post that has a core with at least one single, continuous board of high grade timber that extends along the entire length of the newel post. A laminate is applied around the lower portion of the core to cover minor inconsistencies in the timber. The single board is naturally formed and is free of any joints to make up its length. One or more additional boards of high quality wood may be glued along the length of the side wall of that single, continuous board if a thicker block of high grade wood is needed to manufacture the newel post. At least one of these additional boards may be shorter in length than the single board and have a second end which terminates a distance inwardly from a second end of the single board. A secondary piece of wood is then secured along the side wall of the single board to equalize the lengths of the single and additional boards. The secondary piece of wood is separated from the second board by a gap, thereby negating the need to form finger joints between the two. The secondary piece of wood is made from one of a high quality timber, laminated veneer lumber (LVL) and plywood that are free of pine.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front view of a railing including a newel post in accordance with the present invention;

FIG. 2 is a cross-sectional side view of a first embodiment of the newel post taken through line 2-2 of FIG. 1;

FIG. 3 is a cross-sectional top view through an alternative construction of the first embodiment of the newel post through line 3-3 of FIG. 1;

FIG. 4 is a cross-sectional top view through a second embodiment of the newel post taken through line 3-3 of FIG. 1;

FIG. 5 is a cross-sectional side view of the second embodiment of the newel post taken through line 2-2 of FIG. 1; and

FIG. 6 is a cross-sectional side view of the third embodiment of the newel post taken through line 2-2 of FIG. 1.

### DETAILED DESCRIPTION OF THE INVENTION

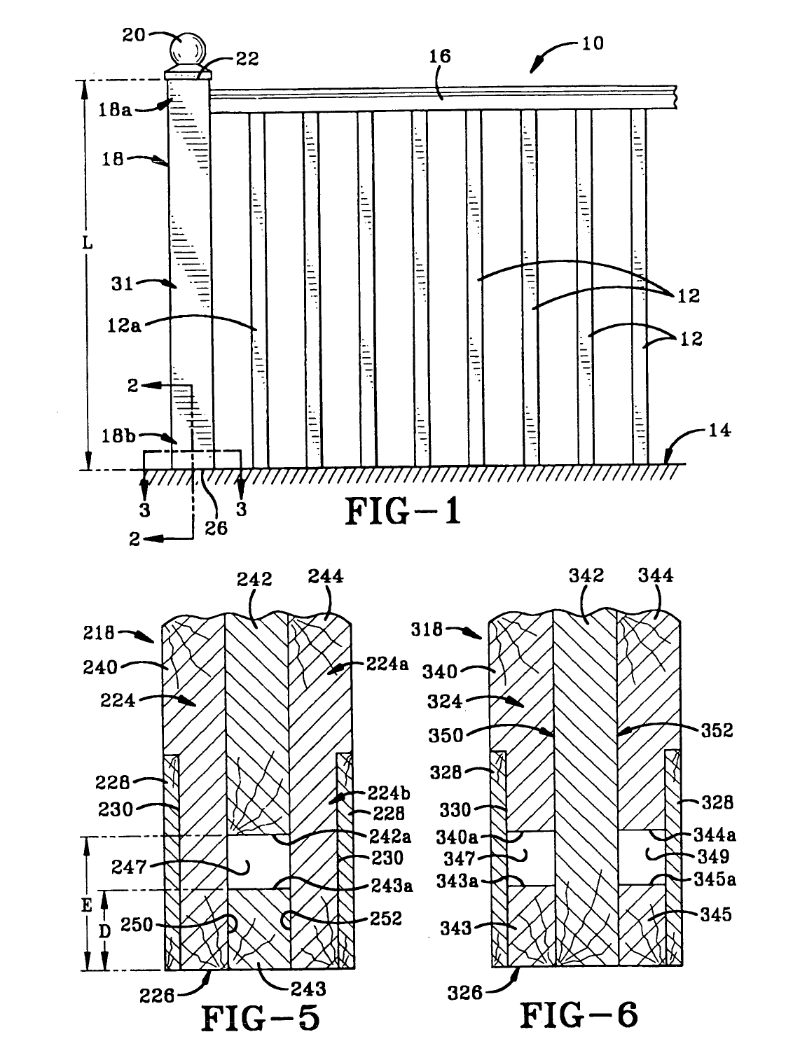

Referring to FIG. 1, there is shown a railing 10 comprising a plurality of balusters 12 extending upwardly from a surface 14 and being connected together along their uppermost ends by a handrail 16. The surface 14 may be a wooden floor, as illustrated in FIG. 1, a stair tread or any other suitable horizontal surface 14. A newel post in accordance with the present invention is connected to a first end of railing 10 and is generally indicated at 18. Newel post 18 has an upper portion 18a proximate railing 10, a lower portion 18b proximate surface 14 and may include a decorative cap 20 mounted on uppermost end 22 of upper portion 18a. Newel post 18 is illustrated as uniformly square in cross-section along its entire length “L”, but it will be understood that post 18 may be decoratively shaped in any manner known in the art and may include areas that are generally circular in cross-sectional shape and of various diameters.

FIG. 2 shows the internal construction of a first embodiment of newel post 18 in accordance with the present invention. In this instance, newel post 18 comprises a core 24 that includes at least a single, continuous piece of timber 41 which extends from the uppermost end 22 (FIG. 1) of newel post 18 down to the lowermost end 26 thereof. The timber used can be any high grade hardwood species, for example, red oak, cherry, walnut, ash, maple, poplar etc. Timber 41 is a single continuous piece of wood which is naturally formed, is of a length “L” (FIG. 1) and a width “Y” (FIG. 2) and has no joints therein to form length “L” or width “Y”. In such a piece of timber 41, it is possible that one end thereof will be of a less desirable external appearance than the other end thereof. This would occur if one end included inconsistencies such as small holes, cracks or knots that are insufficiently severe enough to require the removal of that end of the piece of timber 41 for being defective and of a lower grade, but which may slightly detract from the overall appearance of newel post 18. Consequently, when the craftsman is forming newel post 18, he will orient the piece of timber 41 so that the aesthetically more pleasing first end 24a of core 24 will become the upper portion 18a of newel post 18 and a second end 24b of core 24 will be less aesthetically pleasing and will become the lower portion 18b of newel post.

In accordance with a specific feature of the present invention, a laminate 28 is adhesively or otherwise secured around the outermost perimeter 29 of end 24b of newel post 18 that includes more inconsistences. So, for example, if the outermost perimeter 29 of post 18 is square in cross-section, then laminate 28 will be applied to all four walls that form that square shape. Laminate 28 may be applied as a single continuous sheet or may be applied in smaller sections to cover the perimeter 29. End 24b of core 24 preferably is provided with a recessed region 30 (FIG. 2) that is of a smaller cross-sectional width “W” than the width “Y” of the portion of end 24a that is disposed immediately above end 24b. Laminate 28 is applied to core 24 in recessed region 30 and, consequently, the exterior surface 28a of laminate 28 lies substantially flush with the exterior surface 31 of core 24. It will, of course, be understood that if newel post 18 is decoratively shaped proximate end 24b, then laminate 28 will encircle the decoratively shaped region. Recessed region 30 may also be omitted from post 18 and laminate 28 would then simply be applied over the external surface 31 of core 24.

Laminate 28 preferably comprises high grade timber strips of the same species of wood as that of upper portion 18a of newel post 18. Alternatively, laminate may be a substantially continuous veneer that has the same external appearance as does the wood of upper portion 18a. So, for instance, both the core 24 and laminate 28 may be made from any hardwood species such as red oak, cherry, walnut, ash, maple, poplar woods etc.

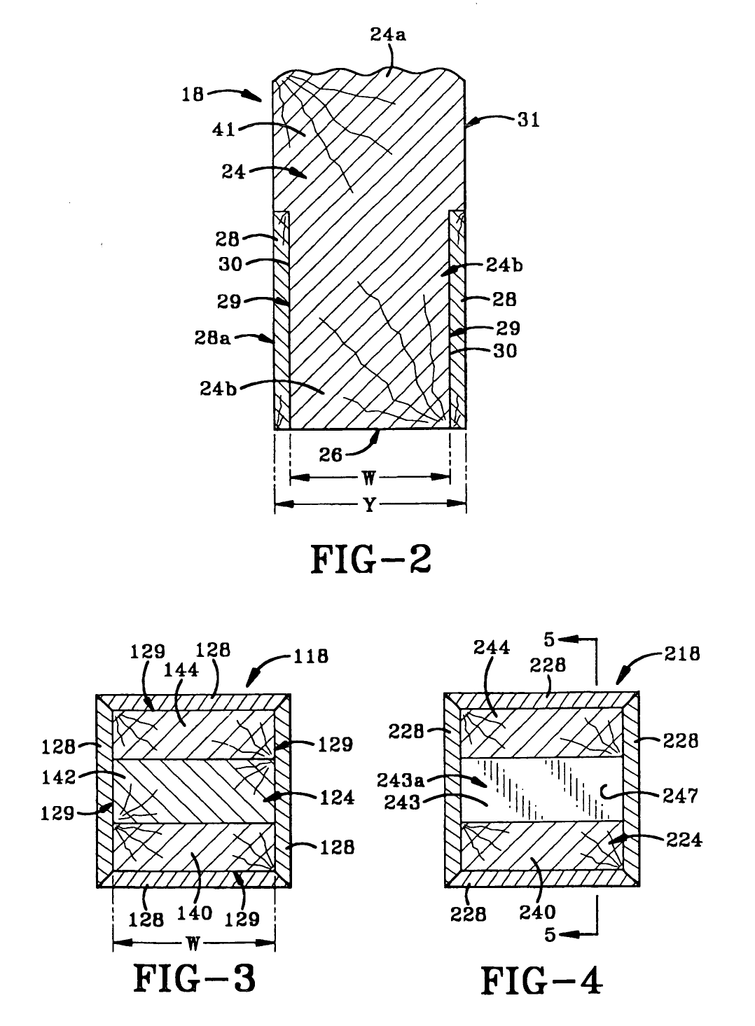

FIG. 3 illustrates an alternative internal construction of a first embodiment of a newel post in accordance with the present invention and generally indicated at 118. Newel post 118 comprises a core 124 made up from a plurality of boards 140, 142, 144 of high quality wood that are joined together along their side walls by any suitable means such as by an adhesive. All of these boards are single, continuous pieces of timber that extend along the entire length of post 118 from its uppermost end (not shown) to its lowermost end (not shown). These single, continuous pieces of timber are naturally formed and are not comprised of smaller pieces that have been finger-jointed together to make up the length of the board. As such, boards 140, 142, 144 are free of joints along their entire lengths. When boards 140-144 are joined together, care is taken to ensure that if any of the boards have minor exterior inconsistencies therein, then they are oriented to position those less aesthetically pleasing regions all at one end of the core. A laminate 128 is applied around the perimeter 129 of core 124 and over the less aesthetically pleasing regions to hide the same from view.

Alternatively, as shown in FIGS. 4 & 5, a second embodiment of newel post in accordance with the present invention is shown and generally indicated at 218. Newel post 218 includes a core 224 that comprises a plurality of high grade timber boards 240, 242, 244 that are secured together along their side walls by an adhesive or other suitable connection means. At least two of these boards, namely 240 and 244, each comprise a single, continuous piece of timber that extends from the uppermost end (not shown) of newel post 218 to the lowermost end 226 thereof. These single, continuous pieces of timber are each naturally formed and are free of joints along their entire lengths “L” as illustrated in FIG. 1. Either one or both of these boards 240, 244, while entirely made from high grade timber, may have one end that is of a less desirable external appearance, i.e., it has inconsistencies such as small holes, cracks or knots that are insufficiently severe enough to require the removal of that end for being defective, but which may slightly detract from the overall appearance of the timber. As a consequence, the craftsman will orient boards 240, 244 so as to position their aesthetically more pleasing ends together, thereby causing the less aesthetically pleasing ends of the boards to be grouped together. Consequently, a first end 224a of core 224 is more aesthetically pleasing and this will become the upper portion of newel post 218 and a second end 224b of core 224 will be less aesthetically pleasing and will become the lower portion of newel post.

Still referring to FIGS. 4 and 5, and in accordance with a specific feature of the present invention, at least one board, in this case board 242, is not long enough to extend all the way down to lowermost end 226 of newel post 218. A secondary piece of wood 243 is utilized as a filler to equalize the length of board 242 with those of boards 240 and 244. Secondary piece 243 is glued between the side walls 250 and 252 of boards 240 and 244, respectively (FIG. 5). Furthermore, in order to reduce the labor and time involved with having to cut a perfectly sized secondary piece 243, this piece is sized to have a length “D” that is smaller the distance “E” from the bottom 242a of board 242 and the lowermost end 226 of post 218. A gap 247 is therefore formed between second end 242a of board 242 and first end 243a of piece 243.

In accordance with another specific feature of the present invention, secondary piece 243 preferably is made from a higher quality timber that is relatively free of defects. That higher quality wood may come from the same species of tree as boards 240, 242 and 244. As with the previous embodiment, laminate 228 preferably is secured around the outer perimeter 229 of a recessed region 230 of core 224 of post 218. Laminate 228 extends upwardly from lowermost end 226, of post 218 to a point spaced a distance further away from lowermost end 226 than is end 242a.

Referring to FIG. 6, there is shown a third embodiment of a newel post in accordance with the present invention and generally indicated at 318. Post 318 is constructed out of a plurality of boards at least one of which, namely board 342, is a single, continuous piece of timber that extends from the uppermost end (not shown) of newel post 318 to the lowermost end 326 thereof. This single, continuous piece of timber is, again, naturally formed and is free of joints along its entire length “L” as illustrated in FIG. 1. Board 342, while entirely made from high grade timber, may have one end that is of a less desirable external appearance in that it has minor inconsistencies therein. As a consequence, the craftsman will orient board 342 so as to orient the aesthetically more pleasing end in such a manner that it will become the uppermost end of post 318.

In post 318 at least two boards 340, 344 are not long enough to extend all the way down to the lowermost end 326 of newel post 318. A secondary piece 343 and tertiary piece 345 of wood are therefore utilized to equalize the length of board 342 with those of boards 340, 344. Pieces 343, 345 are glued to the side walls 350 and 352 of board 342. Secondary and tertiary pieces 343, 345 are smaller than the distances between the ends 340a, 344a and the lowermost end 326 of post 318. Gaps 347, 349 are thereby formed between second ends 342a, 344a and first ends 343a, 345a of pieces 343, 345, respectively. Secondary and tertiary pieces 343, 345 preferably are also made from a higher quality timber that is relatively free of defects. The higher quality wood may come from the same species of tree as boards 340-344.

Laminate 328 preferably is secured around the outer perimeter 329 of a recessed region 330 of post 318. Laminate 328 extends past the ends 340a, 344a of boards 340, 344 so that gaps 347, 349 are completely hidden from view. Pieces 343, 345 are not necessarily cut to the same length as each other and therefore gaps 347, 349 may be of different sizes. Newel post 318 is constructed entirely from high grade timber with pieces 343, 345 serving as a means to equalize the lengths of all the boards 340-344 used in the construction of post 318.

Alternatively, because pieces 343, 345 are covered by laminate 328 when post 318 is viewed from the side, these pieces 343, 345 may also be made from high grade woods of a species different to that of boards 340-344. So, for example, boards 340-344 may be red oak, while pieces 343, 345 are made out of poplar wood. Furthermore, pieces 343, 345 may be made from LVL or plywood, the types of LVL and plywood contemplated for this use being those that are manufactured from materials other than pine wood.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A newel post comprising:
a core that includes at least one single, continuous board of high quality timber that extends from an uppermost end of the newel post to a lowermost end thereof; and wherein said core includes an upper portion and a lower portion; and
a laminate applied around the lower portion of the core.

2. The newel post as defined in claim 1, wherein the single, continuous board is naturally formed and is free of finger joints along its length.

3. The newel post as defined in claim 1, wherein said laminate comprises one of a high quality wood strip and a veneer.

4. The newel post as defined in claim 1, wherein the lower portion of the core includes a recessed region that is of a smaller cross-sectional dimension than is the upper portion of the core; and wherein the laminate is received within the recessed region.

5. The newel post as defined in claim 4, wherein an exterior surface of the laminate is substantially flush with an exterior surface of the upper portion of the core when the laminate is received within the recessed region.

6. The newel post as defined in claim 1, wherein the core is manufactured from any hardwood timber such as red oak, cherry, walnut, ash, poplar, oak and maple.

7. The newel post as defined in claim 1, wherein the laminate is made from a material that corresponds in external appearance to the core of the newel post.

8. The newel post as defined in claim 1, wherein the core further comprises at least a second board that is continuous, of a of high quality timber and extends from the uppermost end of the newel post to the lowermost end thereof; and wherein each of the single and the second boards have a length and a side wall and the single and second boards are joined together along their side walls.

9. The newel post as defined in claim 8, wherein the second board is naturally formed and is free of finger joints along its length.

10. The newel post as defined in claim 1, wherein the timber in the lower portion of the core includes a region of minor inconsistencies and the laminate is applied over at least this region.

11. The newel post as defined in claim 1, wherein the single board has a first and a second end with a first side wall extending therebetween; and wherein the core further comprises at least a second board that has a first and second end with a second side wall extending therebetween; and wherein the single and continuous boards are secured together along their first and second side walls; and wherein the second board is shorter than the single board.

12. The newel post as defined in claim 11, wherein the first ends of the single and second boards are substantially coplanar and the second end of the second board is positioned inwardly of the second end of the single board.

13. The newel post as defined in claim 12, further comprising a secondary piece of wood having a first and second end with a third side wall extending therebetween, and wherein said third side wall of the secondary piece of wood is secured to the first side wall of the single board.

14. The newel post as defined in claim 13, wherein the first end of the secondary piece of wood is spaced a distance apart from the second end of the second board; whereby the second board and secondary piece of wood are separated from each other by a gap.

15. The newel post as defined in claim 14, wherein the second end of the secondary piece of wood is substantially coplanar with the second end of the single board.

16. The newel post as defined in claim 13, wherein the secondary piece of wood is made from a high quality timber that is free of defects.

17. The newel post as defined in claim 13, wherein the secondary piece of wood is made from one of LVL and plywood that is free of pine wood.

18. The newel post as defined in claim 13, further comprising a third board that has first and second ends and a side wall extending therebetween, said side wall of the third board being connected to a side wall of one of the single and second boards; and wherein the third board is of a different length to the one of the single and second boards.

19. The newel post as defined in claim 18, further comprising a tertiary piece of wood that is connected to the side wall of the one of the single and second boards a spaced distance from an inward end of the third board; whereby the inward end of the third board and an interior end of the tertiary piece of wood are separated from each other by a second gap.

20. The newel post as defined in claim 19, wherein the secondary and tertiary pieces of wood and the gap and second gap are covered by the laminate when the newel post is viewed from the side.
